(19) United States
(12) Patent Application Publication
(10) Pub. No.: US 2008/0042399 A1
(43) Pub. Date: Feb. 21, 2008

(54) TOWABLE TRAILER ASSEMBLY

(76) Inventor: Fred P. Smith, Alpine, UT (US)

Correspondence Address: SAND & SEBOLT, AEGIS TOWER, SUITE 1100, 4940 MUNSON STREET, NW, CANTON, OH, 44718-3615, US

(21) Appl. No.: 11/840,630

(22) Filed: Aug. 17, 2007

Related U.S. Application Data
(60) Provisional application No. 60/838,283, filed on Aug. 17, 2006.

(51) Int. Cl. B60D 1/155; B60P 1/28

(52) U.S. Cl. 280/482; 298/23 R

(57) ABSTRACT

A trailer assembly for use with a towing vehicle such as a dump truck. The assembly comprises a pup trailer that has a fixed or a terminally-steerable front axle and an adjustable length tongue that secures the trailer to the towing vehicle. The trailer and tongue are secured to each other by a pivot that has a single lateral axis. The pivot permits vertical pivoting of the trailer and tongue relative to each other through a range of motion that is as much as forty degrees above and below the horizontal. The pivot resists lateral pivoting motion between the tongue and trailer. The assembly permits the trailer to be easily towed over uneven terrain and resists the tendency of the trailer to tip during towing and during dumping.

### CROSS-REFERENCE TO RELATED APPLICATIONS

This application is a standard utility application claiming priority from U.S. Provisional Application Ser. No. 60/838,283, filed Aug. 17, 2006, the entire specification of which is incorporated herein by reference.

### BACKGROUND OF THE INVENTION

1. Technical Field

This invention generally relates to dumping trailers. More particularly, the invention relates to dumping trailers having four or more axles. Specifically, the invention relates to a trailer assembly that includes an extendable tongue which is vertically pivotable about a laterally-oriented pivot rod that connects the tongue to a trailer and which permits the trailer to follow the towing vehicle over uneven terrain without placing high bending moments on the tongue.

2. Background Information

A large truck, such as a dump truck, frequently needs the ability to handle payloads in excess of what the main truck bed can handle. To improve efficiency and in order to be more economically advantageous, such large trucks may pull one or more trailers that are generally referred to as pup trailers. The pup trailers increase the overall load-carrying capacity of these large trucks. Pup trailers typically have fixed axles, meaning axles that have a wheel mounted at each end and which do not pivot. Some of the first pup trailers utilized two fixed axles and their load-carrying bodies were small. As time has passed, the need for carrying even larger, heavier loads has increased. The length of the trailer bodies has therefore been increased to the point that more axles must be provided under the trailer bed to carry the increased loads. Some longer trailer beds have required three fixed axles and even longer beds have required four axles. In these latter instances, the fourth axle has typically been a steerable, liftable axle that typically is added behind the three fixed axles. If the trailer bed is sufficiently long enough to require five axles, then a steerable liftable axle has typically been added both behind and in front of the three fixed axles. It would be possible to add even more axles if the length of the trailer bed requires them for adequate support. A steerable axle is an axle that has one or more vertically oriented king pins that enable the wheels to pivot. The axle may have a single, centrally-located king pin or may have a king pin positioned at either end of the axle and proximate the wheels. In the latter instance, the wheels are connected together by a tie rod that causes the wheels to pivot in unison. For the purpose of this application, a steerable axle having a single, centrally-located king pin will be referred to as a centrally-steerable axle and a steerable axle having a king pin at either end of the axle will be referred to as a terminally-steerable axle.

Laws and regulations, sometimes known as “bridge laws” have been enacted that limits the amount of load a certain axle grouping may carry. These laws are generally based not only on the carrying capacity of the axles, but also on the spacing between the axle groups on the truck and the trailer. Therefore, to maximize the payload that may be carried by a pup trailer, long tongues have been utilized to increase the spacing between the truck and trailer and to thereby comply with these bridge laws. The disadvantage of using a longer tongue is that the maneuverability of the pup trailer is considerably decreased. One method of overcoming this reduced maneuverability has included providing a tongue that can extend and retract in length. Therefore, when the trailer is used on the road, the tongue is extended so that the trailer will comply with the bridge laws. When additional maneuverability is required, such as at a job site, the tongue's length is reduced.

Material hauling trucks and trailers, particularly dump trucks and pup trailers, are often used in unimproved regions where the ground over which the truck and trailer must travel is uneven. It is to be noted that uneven ground exists in improved areas as well, such as in the vicinity of railroad tracks, dips in the road, bottoms and tops of hills, etc. When the elevation or angle above or below horizontal differs between the truck and the trailer, there are instances where the weight of the trailer tends to be supported on the end of the tongue and proximate the rearmost axle on the trailer. There are other times, where the weight of the trailer tends to be supported on the end of the tongue and the foremost axle on the trailer. Typically, in prior known pup trailers, tongues have been fixedly secured to the front end of the trailer. When the trailer only has two or three axles and a small bed that carries lighter loads, a fixed tongue can easily support the weight. However, as trailers have become longer in actual length and heavier, and effectively even longer because of extendable tongues, has necessitated that the tongues themselves have had to be considerably increased in strength. This has required the addition of material to the tongue, and consequently increased the overall weight of the trailer, thus necessitating a reduction in the potential weight of the payload the trailer can carry.

In U.S. Pat. Nos. 3,193,329 and 3,193,330 Hribar, Jr. discloses a dump trailer that has two fixed axle groups on the trailer and a tongue comprising three struts disposed in a triangular pyramidal shape. The lowermost strut is secured to a downwardly and outwardly extending projection on the trailer frame by a spring and an adjusting bolt. The upper struts are connected to the trailer frame by resilient shocks. The resilient connections between the struts and the trailer frame are designed to provide some longitudinally directed movement between the tongue and trailer during towing. The connection arrangement permits very slight vertical movement between the tongue and trailer body. This does reduce the fatigue loading on the tongue that would be caused by small undulations. However, if the terrain is quite uneven or sufficiently steep enough to position the trailer at a different height and/or angle relative to the truck body, the forces at the three connection points between the tongue and trailer frame will be large and tend to lift either the front wheels or rear wheels of the trailer. Thus, the trailer will primarily be supported on the tongue and either the front or rear axles. This loading is likely to break the resilient shocks and/or twist and damage the connection between the lowermost strut and the projection.

Some fixed axle trailers known in the prior art have permitted the tongues connected thereto to articulate to some degree, such as the trailer tongue assembly disclosed in U.S. Pat. No. 4,078,822 issued to Shelquist et al. Shelquist et al discloses a generally V-shaped tongue that includes two diverging legs with the narrowest portion of the tongue disposed remote from the trailer. The legs of the tongue are connected together at intervals by laterally oriented truss components. A longitudinally-aligned strut extends rearwardly from the two truss components adjacent the trailer. The strut extends beyond the front of the trailer's frame and a laterally-oriented leaf spring is mounted to an upper planar surface of the strut. The leaf spring extends outwardly beyond the side edges of the strut and terminates at each end in an eyelet. Bolts are inserted through the eyelets and fixedly secure the spring to brackets that extend downwardly from the trailer's frame. A pair of arms extend forward from each of the brackets to which the spring is secured and a sleeve member on the end of each tongue leg is pivotally secured to one of the pairs of arms by a nut and bolt. This arrangement permits some flexure in the tongue when the trailer is pulled over uneven terrain in that the tongue can pivot very slightly upwardly and downwardly as the trailer moves over uneven terrain. The bending forces acting on the tongue are transmitted to the spring which is able to flex upwardly and downwardly in a vertical plane and thereby reduce the stressing forces on the tongue and trailer. While this type of tongue-pup trailer connection is adequate for traveling down the highway and over slightly uneven terrain, the connection is less able to accommodate situations where the pup trailer is on a steeply inclined slope and the truck is on a horizontal surface or vice versa. In these instances, the degree of flexure in the spring restricts the possible vertical motion of tongue. Furthermore, the position of the connection point between the tongue and trailer being under a portion of the trailer frame, substantially restricts how far upwardly and downwardly the tongue can rotate as the trailer moves over uneven ground. The mechanism permits articulation of the tongue through a defined range of motion that is limited to less than 5 degrees in at least one direction. If the tongue was caused to rotate severely downward by a change in the relative angles between the truck and trailer by traveling over very uneven ground, then the strut on the tongue will tend to engage the underside of the front end of the trailer and tend to lift the rear of the trailer off the ground. This again induces large bending moments in the tongue. These forces may damage the connector components on both the tongue and trailer.

It has furthermore been the consensus in the industry that motion-restricting devices such as springs, cylinders and dampeners are necessary on articulating tongues on pup trailers in order to prevent the trailer from overturning during braking or during dumping. The motion-restricting devices reduce vertical oscillations of the trailer when it is hauled down the road and keep the trailer from dipping downwardly in the front during braking.

Articulating the tongue and using a motion-restricting device is supposed to enable pup trailers to follow trucks over somewhat uneven ground while minimizing the bending moment of the tongue generated by the difference in height, angle and relative positions of the trailer and truck bodies. Theoretically, this would allow the tongue to be made lighter than would be the case for a rigid tongue or would at least help eliminate some of the tongue failures. The difficulty with limiting the motion of the tongue is that a pup trailer may be pulled over significantly uneven terrain that will tend to cause the tongue to reach the limit of its designed range of motion of the spring, stop or dampening device, causing the tongue to become relatively rigid at that point. This applies large bending moments to the tongue that were supposed to be eliminated by the motion-restricting devices. The large bending moments tend to result in failure of the tongue. In fact, in some cases this problem has been actually exacerbated because the tongue had been made lighter and less strong because of the presence of the motion-restricting device. Consequently, a maximum bending moment is applied to the tongue when the possible articulation of the tongue is stopped. Trailer tongues have experienced premature failure for this very reason. Additionally, the provision of motion-restricting devices has required the utilization of additional materials, parts, weight and expense.

There is therefore a need in the art for an improved articulated tongue for connecting a pup trailer to a truck.

### SUMMARY OF THE INVENTION

The device of the present invention comprises a trailer assembly for use with a towing vehicle such as a dump truck. The assembly comprises a pup trailer that has a fixed or a terminally-steerable front axle and an adjustable length tongue that secures the trailer to the towing vehicle. The trailer and tongue are secured to each other by a pivot that has a single lateral axis. The pivot permits vertical pivoting of the trailer and tongue relative to each other through a range of motion that is as much as forty degrees above and below the horizontal. The pivot resists lateral pivoting motion between the tongue and trailer. The assembly permits the trailer to be easily towed over uneven terrain and resists the tendency of the trailer to tip during braking and dumping. The laterally oriented pivot permits a greater degree of vertical pivoting between the tongue and trailer than has previously been utilized. Neither the trailer nor the tongue is provided with any structural mechanism that prevents, restricts or limits the vertical pivotal motion between the trailer and tongue during normal operating conditions. The pivoted tongue of the present invention, with its relatively unrestricted motion, has the advantage of being able to allow the trailer to traverse rough, more uneven terrain without damaging the trailer. Furthermore, the tongue can be manufactured substantially lighter than would be otherwise necessary, thus enabling the trailer to haul more legal payloads without the fear that uneven terrain will load the tongue with a bending moment around the lateral axis that will result in the tongue failing. The present invention also allows for dumping and braking with an unrestricted articulated tongue without the trailer being able to tip over about a lateral axis.

Consistent with the objects of the invention, and in accordance with the invention as embodied and broadly described herein, an apparatus in accordance with the present invention is disclosed as including an adjustable length, pivoted-tongue trailer with four or more axles, none of which rotate about a centrally located, vertical axis. The wheels on these axles are kept in constant engagement with the ground when the truck is at one orientation from level and the trailer is at another.

In the present invention, the tongue extends forward from the front end of the trailer. The tongue has a longitudinal axis that is substantially parallel and longitudinally aligned to the longitudinal axis of the trailer. There is a laterally oriented pivot that connects the tongue to the trailer body. The pivot is at the end of the tongue or at some point longitudinally along the length of the tongue. The pivot extends laterally at right angles to the longitudinal axes of the tongue and trailer. The length of the tongue between the two ends can be adjusted. The pivot mounted laterally on the tongue has no motion-restricting device engaged therewith that would limit the tongue's vertical motion over the possible operating range, i.e., to about 40 degrees above or below the horizontal. The self-supported trailer has no motion-limiting device operationally connected to either the tongue or trailer or acting on the tongue about the pivot. The trailer is therefore able to follow a lead truck over uneven ground without the tongue experiencing any substantial bending moment about the lateral axis. The self-supported trailer exerts substantial forces on the tongue only in the direction needed to pull the trailer to cause it to follow the truck (bending moments about the vertical axis during turning) or moments and substantially longitudinal forces caused as a result of braking or pulling the trailer. The combination of a trailer having a fixed or terminally-steerable front axle, the adjustable length tongue and the laterally-aligned pivot substantially eliminate bending moments about a lateral axis in the tongue as a result of traveling over uneven terrain.

The present invention enables all of the wheels on all of the axles on the towing vehicle and trailer to remain in contact with the ground at all times when the truck is at one orientation from level and the trailer at another. This means that the axles are not intentionally or unintentionally caused to lift the wheels off the ground. This reduces the tendency for the trailer to tip about a lateral axis when dumping a load or during braking. Having all of the wheels on all of the axles on the ground at all times also reduces any vertical oscillation tendency in the trailer.

Having an adjustable length tongue also provides many advantages. If needed, the tongue can be increased in length so that it is sufficiently long enough to meet the requirements of bridge laws. Furthermore, the tongue can be reduced in length, thus improving trailer maneuvering ability when the truck and/or trailer are empty or less full, or when loaded to volumetric capacity with materials of lower density and weight.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is partial side view of a truck and pup trailer incorporating the tongue of the present invention;

FIG. 2 is a top view of the tongue shown at its minimum length;

FIG. 3 is a top view of the tongue shown at an extended length;

FIG. 4 is an enlarged top view of the pivot taken through line 4-4 of FIG. 1; and

FIG. 5 is a partial side view of the truck and pup trailer traveling over uneven terrain.

### DETAILED DESCRIPTION OF THE INVENTION

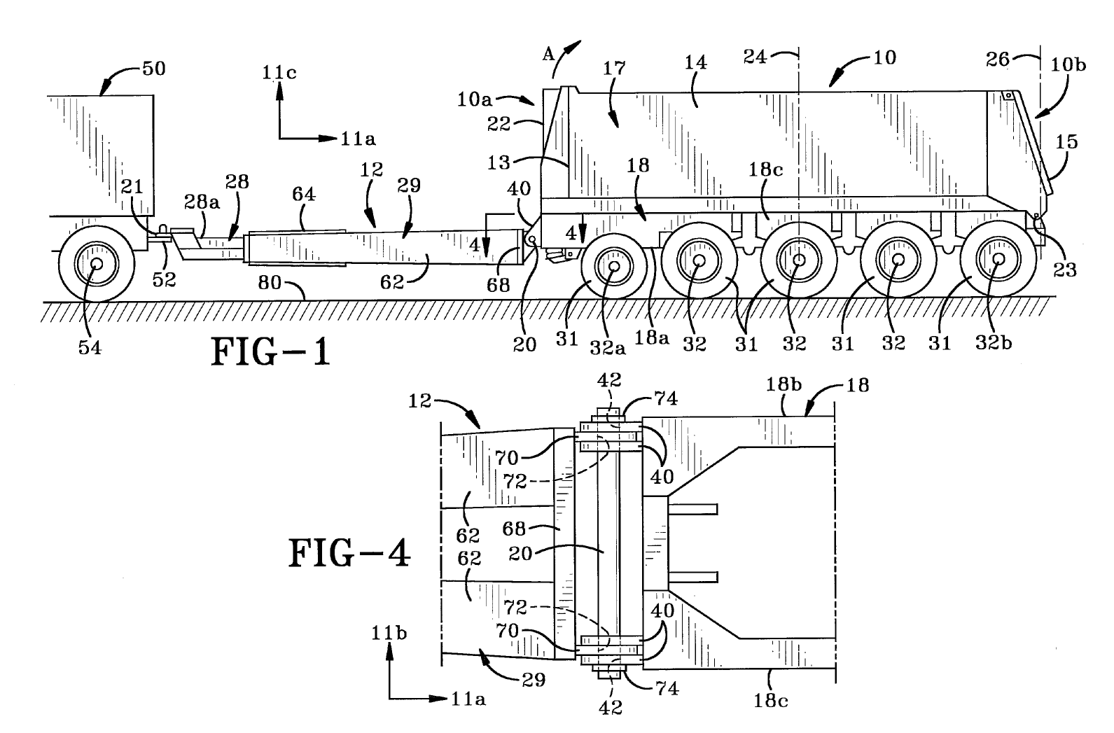

Referring to FIGS. 1-5, there is shown a self-supported trailer in accordance with the present invention and generally indicated at 10. For the purposes of this description, it may be advantageous to define a longitudinal direction “11a”, lateral direction “11b” and transverse direction “11c” positioned to be mutually orthogonal. In general, the longitudinal direction 11a will be aligned with the longitudinal axis of trailer 10. The lateral direction 11b will extend substantially at right angles to the longitudinal axis of trailer 10 and the transverse or vertical direction 11c will be aligned with a direction close to vertical. All directions are relative with respect to trailer 10. Trailer 10 is designed to support and transport a payload therein and to dump the same. Trailer 10 is further designed not to overturn during such operations.

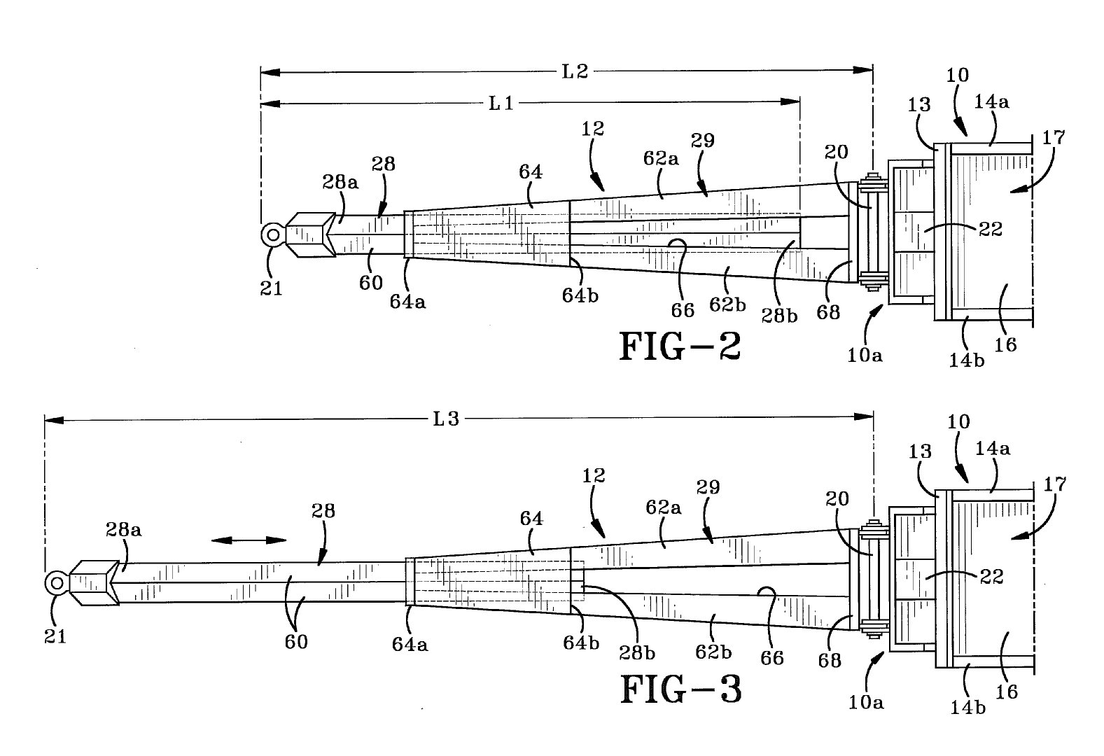

Trailer 10 comprises a front wall 13, a pair of opposed side walls 14, a rear dump door 15 and a floor 16 (FIG. 2). Floor 16 may additionally be supported by longitudinally aligned rails (not shown) positioned under floor 16. Front wall 13, side walls 14, dump door 15 and floor 16 define a load carrying bed 17 that is supported by a sub-frame 18. Multiple suspensions (not shown) and wheels 31 mounted on axles 32, in turn, support sub-frame 18. Each pair of wheels 31 is mounted on an axle 32. In the system illustrated in FIGS. 1&5, at least four axles 32 support bed 17. Specifically, the foremost axle 32a is one of a fixed and a terminally-steerable axle. The rearmost axle 32b may also be a terminally-steerable axle.

Although not shown in any detail, trailer 10 also includes a hoist cylinder 22 that is attached to the front end 10a of trailer 10 between sub-frame 18 and bed 17. Bed 17 is connected to sub-frame 18 at a rear end 10b of trailer 10 by a hoist pivot 23. When hoist cylinder 22 is activated, it causes bed 17 to rotate about hoist pivot 23 in the direction indicated by arrow “A” (FIG. 1). This raises bed 17 from a horizontal position to an inclined dumping position thereby allowing a load (not shown) carried on bed 17 to exit trailer 10 through the pivoted dump door 15.

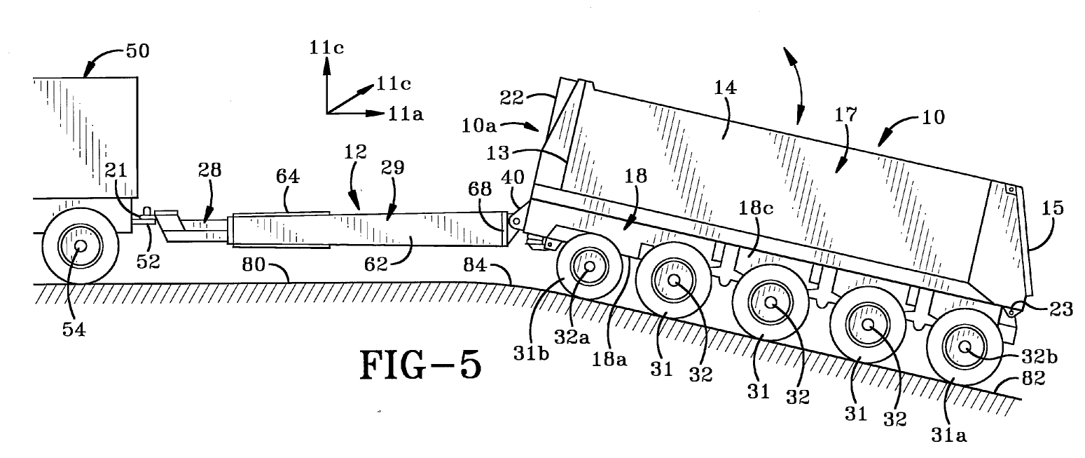

In accordance with a specific feature of the present invention, trailer 10 includes two pairs of spaced apart first flanges 40 that extend forwardly and outwardly from a front end 10a of sub-frame 18. First flanges 40 are positioned at a height that is above the underside 18a (FIG. 1) of sub-frame 18 and proximate side edges 18b, 18c (FIG. 4) thereof. An aperture 42 is defined in each first flange 40 and apertures 42 in the first flanges 40 are aligned one with another. An expandable tongue 12 is used to secure trailer 10 to a towing vehicle 50 such as a dump truck.

In accordance with another specific feature of the present invention and as shown in FIGS. 2 and 3, tongue 12 has two parts, a tongue front 28 and a tongue back 29. Tongue front 28 comprises one or more rails 60 and has a hitch attachment device 21, such as a pintle eye, secured to a first end 28a thereof. Hitch attachment device 21 is designed to be secured to a hitch 52 on vehicle 50. Tongue front 28 has a length “L1” as measured from hitch attachment device 21 to a second end 28b thereof. Tongue back 29 comprises a pair of legs 62 and a base 64. A first end 64a of base 64 includes an aperture (not numbered) through which rails 60 of tongue front 28 are slidably received. Legs 62 extend outwardly and rearwardly from a second end 64b of base 64. Legs 62 diverge away from each other to form a generally V-shaped member when viewed from above. A tapered gap 66 is defined between legs 62a, 62b. A bar 68 extends from an outer edge of leg 62a to an outer edge of leg 62b. A pair of spaced apart second flanges 70 extend rearwardly from bar 68. Each second flange 70 defines an aperture 72 therein. Each aperture 72 is alignable with the apertures 42 in first flanges 40.

In accordance with another specific feature of the present invention, tongue 12 is adjustable in length between a minimum length L2 and a maximum length L3. When tongue 12 is at its minimum length L2, tongue front 28 extends only partially out of first end 64a of base 64. When tongue 12 is to be extended, tongue front 28 is slid outwardly for a distance by sliding tongue front 28 out of the aperture in base 64. When tongue front 28 is slid outwardly to its greatest degree, the length of tongue 12 is at a maximum length L3. Tongue 12 is reduced in length by pushing tongue front 28 inwardly into gap 66. A locking mechanism (not shown) is provided for securing tongue 12 at a desired length.

In accordance with yet another specific feature of the present invention, a pivot rod 20 extends through the aligned apertures 42, 72 in first and second flanges to secure trailer 10 to tongue 12. For purposes of this application, pivot rod 20 comprises one or more coaxial metal bars that extend in a lateral direction 11b across sub-frame 18. The attached figures show a pivot rod 20 that is a single, unitary bar that extends substantially from one side 14a of trailer 10 to the other side 14b thereof. Pivot rod 20 has a single lateral axis and is the only structural connection between tongue 12 and trailer 10. Pivot rod 20 is secured in place by suitable connectors 74. It should be noted that there are no stops or obstructions provided on tongue 12, first flanges 40, second flanges 70, or on sub-frame 18 to prevent significant relative rotation of tongue 12 and trailer 10 pivot rod 20. Tongue 12 and trailer 10 are therefore free to rotate relative to each other about pivot rod 20 through as much as plus or minus forty degrees relative to the horizontal. Tongue 12, because of its unrestricted motion about pivot rod 20 is therefore useful to enable trailer 10 to be moved across more uneven terrain than was possible with previously known pup trailers, without damage being done to trailer 10.

Bed 17 of trailer 10 has a bed-load center, indicated at 24 (FIG. 1), that is positioned forward of the rearmost suspension associated with rearmost wheel 31a. Overturning of trailer 10 can occur if the load center 26 of the trailer and load shifts to behind the rearmost suspension. This is most likely to occur during dumping, particularly if the dump door 15 remains closed. Tongue 12 and trailer 10 of the present invention are connected together and axles placed in such a manner that the bed load center 24 is always in a position that is forward of the rearmost axle. Furthermore, the load center 26 always remains forward of the rearmost axle on the trailer, even during dumping on a 10% grade.

FIG. 5 shows vehicle 50 on a substantially horizontal surface 80 and trailer 10 on a severely inclined surface 82. As there are no stops or obstacles to restrict the pivotal motion between tongue 12 and trailer 10, wheels 31b remain in contact with surface 82. Bed-load center 24 is far enough forward of the rearmost suspension associated with wheels 31a to prevent overturn of trailer 10 due to load center 26 being behind the rearmost suspension.

In use, tongue 12 is connected to vehicle 50 by securing hitch attachment device 21 on tongue 12 to hitch 52 on vehicle 50. The driver determines what length of tongue 12 needs to be provided between axle 54 on vehicle 50 and axle 32a (FIG. 5) on trailer 10. If it is decided that a longer tongue 12 is required, the brakes (not shown) on trailer 10 are applied, and the driver drives vehicle 50 forwardly away from trailer 10 so that tongue front 28 slides outwardly away from base 64 of tongue back 29. When the appropriate length of tongue 12, such as length L3 is reached, tongue front 28 is locked into position by engaging the provided locking mechanism (not shown). The brakes are disengaged and vehicle 50 may then be driven over surface 80 pulling trailer 10 behind it.

If the load (not shown) in trailer 10 is to be dumped down a steeply inclined surface, such as 82, vehicle 50 is reversed so that trailer 10 rests on inclined surface 82 and vehicle 50 remains on horizontal surface 80. As trailer 10 transitions the ridge 84 between surfaces 80 and 82, sub-frame 18 pivots vertically about pivot rod 20.

The device of the present invention does not include any physical stops or limiting devices that are operationally connected to the tongue 12 or trailer 10 and that would limit the pivotal motion between the tongue 12 and trailer 10 during normal operation. During normal operating conditions, the tongue 12 and trailer 10 can pivot relative to each other through a range of motion between about forty degrees above the horizontal to about forty degrees below the horizontal, without encountering any obstructions to that pivotal movement by components on either of the tongue or trailer.

As there are no structural stops or obstacles on tongue 12 or trailer 10 that will restrict the pivotal motion between the trailer's sub-frame 18 and tongue 29 during normal operating conditions, the wheels 31 on trailer 10 tend to remain in contact with surface 80, ridge 84 and surface 82 at all times when vehicle 50 is at one orientation from level and the trailer 10 at another. When vehicle 50 has been reversed to the point that the appropriate dumping zone is reached, hoist cylinder 22 is activated so that front end 10a of trailer 10 is raised as bed 17 pivots about hoist pivot 23. The load slides outwardly from bed 17 through dump door 15. Once the load has exited bed 17, hoist cylinder 22 is activated to lower bed 17 back toward sub-frame 18. Vehicle 50 is driven forwardly so that trailer 10 is pulled back over lip 84 and onto surface 82. As front end 10a of trailer 10 passes over lip 84, sub-frame 18 thereof pivots about pivot rod 20. This permits trailer 10 to be pulled over a ridge without inducing a bending moment into tongue 12 of trailer 10.

If at some stage it is decided that tongue 12 is too long, then the brakes on trailer 10 are locked, the locking mechanism on tongue 12 is disengaged and the driver reverses vehicle 50 back toward trailer 10. Tongue front 28 is slid rearwardly into base 64. When tongue 12 is at the appropriate length, then the locking mechanism is engaged. The brakes on trailer 10 are released and vehicle 50 can then be used to tow trailer 10.

The present invention has been tested in the field by causing a towed pup trailer to be reversed from a horizontal surface and over an incline of about twenty degrees while the towing vehicle remained on the horizontal. When the pup trailer was on the incline and the vehicle was on the horizontal surface, the trailer was activated to dump its load. After dumping, the trailer was lowered and driven forwardly back onto the horizontal. During this entire procedure, the trailer did not tip over or even begin to tip over. Furthermore, with the vehicle on the horizontal surface and the trailer on the twenty degree incline, all the wheels on both the towing vehicle and the pup trailer remained in constant contact with the ground.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. A trailer assembly comprising:
a trailer having a load-carrying bed and a plurality of pairs of wheels, each pair of wheels being mounted on an axle; wherein said bed has a front end and a back end and a longitudinal axis extending therebetween; and wherein at least a first axle proximate the front end of the trailer is one of a fixed and a terminally-steerable axle;
a tongue that is adjustable in length between a maximum length and a minimum length; and wherein said tongue has a first end and a second end; and a longitudinal axis between said first and second end; and
a pivot which secures the front end of the trailer to the second end of the tongue; said pivot being oriented substantially at right angles to the longitudinal axes of the trailer bed and tongue; whereby said tongue and trailer are able to pivot vertically about said pivot.

2. The trailer assembly as defined in claim 1, wherein said trailer bed comprises a front wall, a back wall, a pair of side walls and a floor that surround and define a cavity adapted to receive the load; and wherein said pivot is formed with a single rod.

3. The trailer assembly as defined in claim 1, further comprising at least one pair of first flanges extending outwardly and forwardly away from the front end of the trailer;
a pair of spaced apart second flanges extending outwardly and rearwardly from the second end of the tongue; wherein each of said first and second flanges define an aperture therein; and wherein said apertures are alignable with each other; and
a pivot rod extends through said aligned apertures to form the pivot.

4. The trailer assembly as defined in claim 3, further comprising a second pair of first flanges extending outwardly away from the front end of the trailer.

5. The trailer assembly as defined in claim 4, wherein each second flange is received between the flanges of one of the pairs of first flanges.

6. The trailer assembly as defined in claim 1, wherein said trailer further comprises a sub-frame which supports the load-carrying bed thereon; and wherein said pairs of first flanges extend outwardly and forwardly away from said sub-frame.

7. The trailer assembly as defined in claim 6, wherein the pairs of first flanges extend outwardly from a front end of the sub-frame; and one of the pairs of first flanges is proximate a first longitudinal side edge of the sub-frame; and the other of the pairs of first flanges is disposed proximate a second longitudinal side edge of the sub-frame.

8. The trailer assembly as defined in claim 7, wherein the pairs of first and second flanges are further positioned vertically above an underside surface of the sub-frame.

9. The trailer assembly as defined in claim 1, wherein said tongue comprises:
a tongue front having a first end and a second end, and
a tongue back having a first end and a second end; said first end of said tongue back being configured to adjustably engage the second end of the tongue front.

10. The trailer assembly as defined in claim 9, wherein the tongue front further includes a hitch attachment device secured to the first end of the tongue front; said hitch attachment device being adapted to be secured to a hitch on a towing vehicle.

11. The trailer assembly as defined in claim 9, wherein said tongue back includes an aperture in said first end; and wherein said second end of the tongue front is slidably receivable through said aperture; and wherein said tongue front is slid in a first direction to increase the length of the tongue and said tongue front is slid in a second direction to decrease the length of the tongue.

12. The trailer assembly as defined in claim 11, wherein said tongue back comprises:
a base in which the aperture is defined;
a bar;
a pair of legs extending between said base and said bar; and
a gap defined between said legs; said gap being sized to receive the second end of the tongue front therein.

13. The trailer assembly as defined in claim 12, wherein said legs originate in said base and diverge away from each other; and wherein said gap increases in width from proximate the base to proximate the bar.

14. The trailer assembly as defined in claim 13, further comprising at least one pair first flanges extending outwardly and forwardly away from the front end of the trailer; and
a pair of spaced apart second flanges extending outwardly and rearwardly from the bar on the tongue back; wherein each of said first and second flanges define an aperture therein; and wherein said apertures are alignable with each other and the pivot rod extends through said aligned apertures.

15. The trailer assembly as defined in claim 1, wherein the trailer includes four or more axles and four or pairs of wheels associated therewith.

16. The trailer assembly as defined in claim 1, wherein the trailer further comprises;
a sub-frame disposed beneath the load-carrying bed;
a hoist pivot securing the back end of the bed to the sub-frame;
a hoist cylinder operationally engaged with the front end of the bed and being activatable to selectively raise and lower the front end of the bed with respect to the sub-frame.

17. The trailer assembly as defined in claim 16, wherein the bed further comprises a pivotally mounted dump door at the back end thereof; said dump door being pivoted into an open position when the hoist cylinder is activated to raise the front end of the bed away from the sub-frame.

18. The trailer assembly as defined in claim 1, wherein the pivot rod is substantially parallel to the foremost axle and the trailer is pivotable about an axis that is parallel to the foremost axle, whereby the trailer is able to follow the towing vehicle over uneven terrain without placing bending moments on the tongue.

19. The trailer assembly as defined in claim 1, wherein the adjustable tongue and trailer are able to pivot to around forty degrees above and below the horizontal.

20. The trailer assembly as defined in claim 1, wherein the bed of the trailer has a load center and said load center shifts between a foremost position when the bed is in a towing orientation and a rearmost position when the bed is in a dumping orientation; and wherein the load center remains forward of the rearmost axle on the trailer when the bed is both the towing and the dumping orientations.

21. A trailer assembly comprising:
a trailer having a load-carrying bed and a plurality of pairs of wheels, each pair of wheels being mounted on an axle; and wherein at least a first axle proximate a front end of the trailer is a terminally-steerable axle;
an adjustable length tongue that is adapted to be secured to a towing vehicle at a first end; and
a pivot; wherein said pivot has a single lateral axis and wherein the only structural connection between said trailer and a second end of said tongue is the pivot.
